(19) United States
(12) Patent Application Publication
(10) Pub. No.: US 2018/0077309 A1
(43) Pub. Date: Mar. 15, 2018

(54) IMAGE PROCESSING DEVICE, METHOD, AND NON-TRANSITORY RECORDING MEDIUM

(71) Applicant: Takayuki SAITOH, Kanagawa (JP)

(72) Inventor: Takayuki SAITOH, Kanagawa (JP)

(73) Assignee: Ricoh Company, Ltd., Tokyo (JP)

(21) Appl. No.: 15/700,612

(22) Filed: Sep. 11, 2017

(30) Foreign Application Priority Data
Sep. 13, 2016 (JP) 2016-178669

(51) Int. Cl. H04N 1/00; H04N 1/409; H04N 1/387

(52) U.S. Cl. CPC H04N 1/00816; H04N 2201/0094; H04N 1/3878; H04N 1/4092

(57) ABSTRACT

An image processing device includes a processor. The processor extracts a target image including a document area from a scanned image of a plurality of documents laid on a reading surface; performs skew correction to the target image extracted; detects edges in an X-axis direction and a Y-axis direction from the target image after the skew correction; compares the edges with a frame line of a candidate size that is a candidate for a document size, to calculate a fitness of the candidate size; determines the candidate size for which a maximum fitness is calculated, as a cut out size; and cuts out an image of the cut out size determined, from the target image.

### CROSS-REFERENCE TO RELATED APPLICATIONS

This patent application is based on and claims priority pursuant to 35 U.S.C. § 119(a) to Japanese Patent Application No. 2016-178669, filed on Sep. 13, 2016, in the Japan Patent Office, the entire disclosure of which is hereby incorporated by reference herein.

### BACKGROUND

### Technical Field

Aspects of the present disclosure relate to an image processing device, a method, and a non-transitory recording medium.

### Related Art

A technique is known that cuts out images of a plurality of documents from a scanned image of a reading surface on which the plurality of documents is laid.

For example, an image processing device is known that is capable of dividing a scanned image of a reading surface on which a plurality of post card documents is laid, and cutting out image data of each post card.

### SUMMARY

In an aspect of the present disclosure, there is provided an image processing device includes a processor. The processor extracts a target image including a document area from a scanned image of a plurality of documents laid on a reading surface; performs skew correction to the target image extracted; detects edges in an X-axis direction and a Y-axis direction from the target image after the skew correction; compares the edges with a frame line of a candidate size that is a candidate for a document size, to calculate a fitness of the candidate size; determines the candidate size for which a maximum fitness is calculated, as a cut out size; and cuts out an image of the cut out size determined, from the target image.

In another aspect of the present disclosure, there is provided a method of cutting out images of a plurality of documents from a scanned image of the plurality of documents laid on a reading surface. The method includes extracting a target image including an document area from the scanned image; performing skew correction to the target image extracted; detecting edges in an X-axis direction and a Y-axis direction from the target image after the skew correction; comparing the edges with a frame line of a candidate size that is a candidate for a document size, to calculate a fitness of the candidate size; determining the candidate size for which a maximum fitness is calculated, as a cut out size; and cutting out an image of the cut out size determined, from the target image.

In still another aspect of the present disclosure, there is provided a non-transitory recording medium storing program codes that causes an image processing device to execute a method. The method includes extracting a target image including a document area from a scanned image of a plurality of documents laid on a reading surface; performing skew correction to the target image extracted; detecting edges in an X-axis direction and a Y-axis direction from the target image after the skew correction; comparing the edges with a frame line of a candidate size that is a candidate for a document size, to calculate a fitness of the candidate size; determining the candidate size for which a maximum fitness is calculated, as a cut out size; and cutting out an image of the cut out size determined, from the target image.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1 is a functional block diagram of an image processing device according to an embodiment of the present disclosure;

FIGS. 2A and 2B each are a diagram illustrating an arrangement aspect of a document corresponding to an operation mode of the image processing device of FIG. 1;

FIG. 3 is a flowchart illustrating processing executed in a first operation mode;

FIGS. 4A to 4C are conceptual diagrams for describing processing executed by a document area extractor and a contour line extractor;

FIGS. 5A to 5D are conceptual diagrams for describing processing executed by a target image extractor, a skew corrector, and an edge detector;

FIGS. 6A to 6C are conceptual diagrams for describing processing executed by a shortest distance identifier and a candidate size selector;

FIG. 7 is a diagram illustrating a candidate size management table;

FIGS. 8A to 8D are diagrams for describing processing executed by a fitness calculator;

FIGS. 9A to 9C are diagrams for describing processing executed by a document image cut out unit;

FIG. 10 is a flowchart illustrating processing executed in a second operation mode;

FIGS. 11A and 11B are conceptual diagrams for describing processing executed in the second operation mode;

FIGS. 12A and 12B are conceptual diagrams for describing processing executed in the second operation mode;

FIGS. 13A and 13B are conceptual diagrams for describing a method for determining a reference point;

FIGS. 14A to 14D are conceptual diagrams for describing a method for determining the reference point;

FIGS. 15A to 15C are conceptual diagrams for describing a method for determining the reference point; and

FIG. 16 is a hardware configuration diagram of the image processing device according to an embodiment of the present disclosure.

The accompanying drawings are intended to depict embodiments of the present disclosure and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Hereinafter, the present disclosure will be described with reference to exemplary embodiments; however, embodiments of the present disclosure are not limited to the embodiments described below. Incidentally, in the drawings referred to below, the same reference numerals are used for common elements, and the description of the elements will be omitted as appropriate.

An image processing device 100 according to an embodiment of the present disclosure is a device that performs image processing to a scanned image of two or more documents laid on a reading surface (contact glass=document holder) of a scanner, and cuts out an individual image of document (hereinafter, referred to as a document image) from the scanned image.

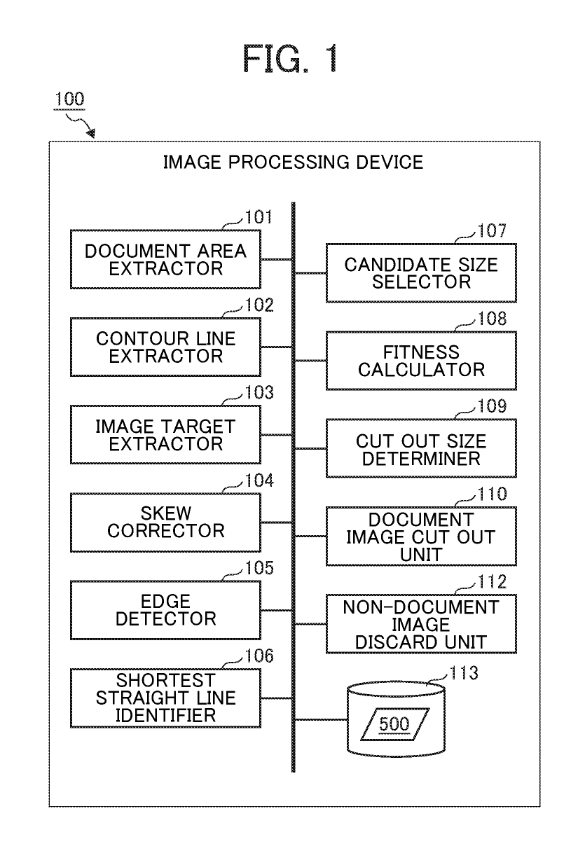

FIG. 1 illustrates a functional block of the image processing device 100 according to the present embodiment. As illustrated in FIG. 1, the image processing device 100 according to the present embodiment includes a document area extractor 101, a contour line extractor 102, a skew corrector 104, a target image extractor 103, an edge detector 105, a shortest straight line identifier 106, a candidate size selector 107, a fitness calculator 108, a cut out size determiner 109, a document image cut out unit 110, a non-document image discard unit 112, and a storage area 113.

The document area extractor 101 extracts a document area from the scanned image of two or more documents laid on the reading surface.

The contour line extractor 102 extracts a contour line of the document area.

The target image extractor 103 extracts a target image to be processed including the document area from the scanned image.

The skew corrector 104 performs skew correction to the target image extracted.

The edge detector 105 extracts edges in an X-axis direction and a Y-axis direction from the target image after the skew correction.

The shortest straight line identifier 106 identifies a first straight line having the shortest length in the X-axis direction and a second straight line having the shortest length in the Y-axis direction, from among straight lines constituting the contour line of the document area.

The candidate size selector 107 selects one or more document sizes each of which has a horizontal length equal to or less than the length of the first straight line and a vertical length equal to or less than the length of the second straight line, as candidate sizes, from among a plurality of document sizes.

The fitness calculator 108 compares the edges extracted from the target image with a frame line of each of the selected candidate sizes to calculate the fitness of each of the candidate sizes.

The cut out size determiner 109 determines one of the candidate sizes for which the maximum fitness is calculated, as a cut out size.

The document image cut out unit 110 cuts out an image of the determined cut out size, from the target image.

The non-document image discard unit 112 discards a non-document image on which no document is shown, from among the images cut out from the target image.

The storage area 113 stores the scanned target image, the document image cut out from the scanned image, a candidate size management table (described later), and the like.

Incidentally, in the present embodiment, a computer constituting the image processing device 100 executes a predetermined program, whereby the image processing device 100 executes functions described above. Here, as the computer constituting the image processing device 100, an embedded computer mounted on a multi function peripheral (MFP), a personal computer, or the like can be exemplified.

In the above, a functional configuration of the image processing device 100 according to the present embodiment has been described. Next, operation modes of the image processing device 100 will be described. Regarding processing of cutting out the document image from the scanned image of the reading surface on which two or more documents are laid, the image processing device 100 according to the present embodiment has two operation modes described below.

(First Operation Mode)

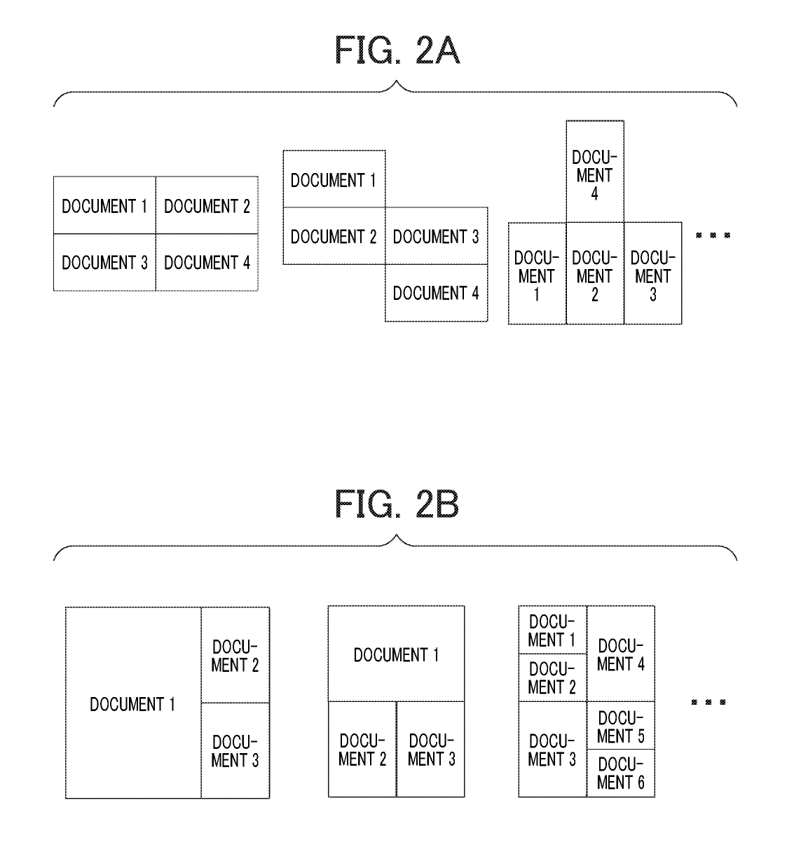

A first operation mode is an operation mode to be selected in a case where documents of the same size are laid on the reading surface. In the present embodiment, as illustrated in FIG. 2A, as far as the documents of the same size are arranged in an aspect such that vertexes of the documents match each other, the documents may be laid in any aspect.

(Second Operation Mode)

A second operation mode is a mode to be selected in a case where the documents are laid in a rectangular shape on the reading surface. In the present embodiment, as illustrated in FIG. 2B, as far as an area in which the documents are laid has a rectangular outline, the documents may be laid in any aspect. Incidentally, if a condition is satisfied that the aspect ratios of all documents are the same (for example, silver ratio), and the size of each document is an integral multiple of the size of other documents (for example, 2ⁿ times: n is an integer), the documents can be laid in a rectangular shape.

In the above, the operation modes of the image processing device 100 according to the present embodiment has been described. Subsequently, detail of processing executed by the image processing device 100 according to the present embodiment will be described. First, the detail of the processing executed in the “first operation mode” by the image processing device 100 according to the present embodiment will be described with reference to a flowchart illustrated in FIG. 3.

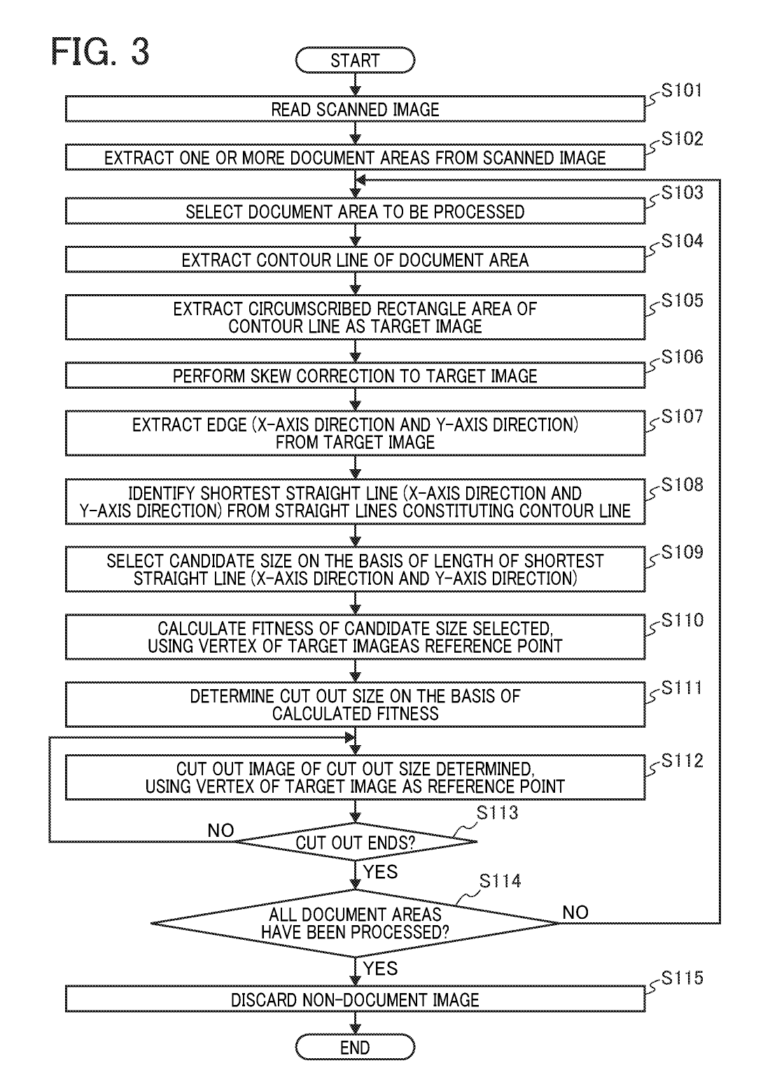

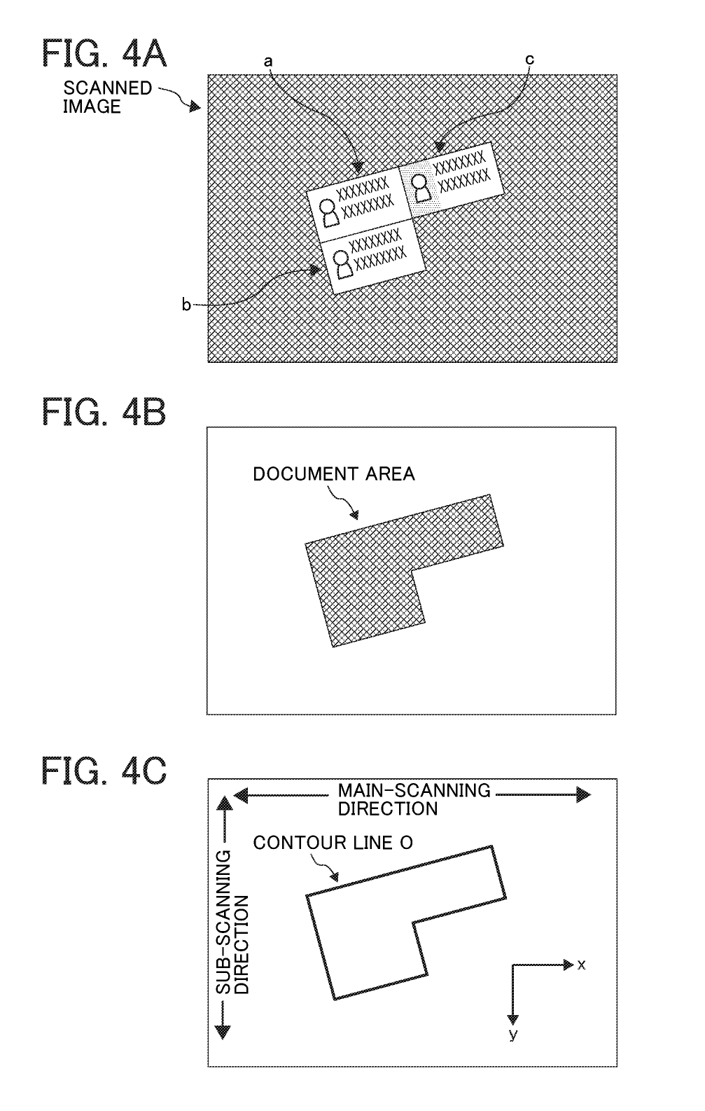

In step S101, the document area extractor 101 reads the scanned image from the storage area 113. FIG. 4A illustrates the scanned image of the reading surface on which three business cards a to c are laid, as an example in which the documents of the same size are laid. In this example, long sides of the business card a and the business card b adjoin each other such that vertexes of the business cards match each other, and short sides of the business card a and the business card c adjoin each other such that vertexes of the business cards match each other.

In subsequent step S102, the document area extractor 101 extracts the document area from the scanned image illustrated in FIG. 4A. FIG. 4B illustrates the document area extracted from the scanned image as a black area. Here, the “document area” means an area in which the document is shown. The document area extractor 101 binarizes (document area: 1, non-document area: 0) the scanned image on the basis of an appropriate threshold, and extracts the document area. Here, the document area extractor 101, in a case where a gap-like non-document area exists between adjacent documents, compares the width of the non-document area with a predetermined distance threshold dₜₕ, and in a case where the width is less than the distance threshold dₜₕ, extracts the documents adjacent to each other via the non-document area, as one document area.

In subsequent step S103, the document area to be processed is selected. In a case where only one document area is extracted as illustrated in FIG. 4B, the one document area is selected. On the other hand, in a case where two or more document areas are extracted in previous step S102, one document area is selected from among the two or more document areas extracted.

In subsequent step S104, the contour line extractor 102 extracts the contour line of the document area selected in step S103. Specifically, a Laplacian filter or the like is used to extract an edge pixel that is a contour of the document area, and the contour line of the document area is acquired as a thin line with a width of one pixel. FIG. 4C illustrates a contour line O of the document area extracted in step S104.

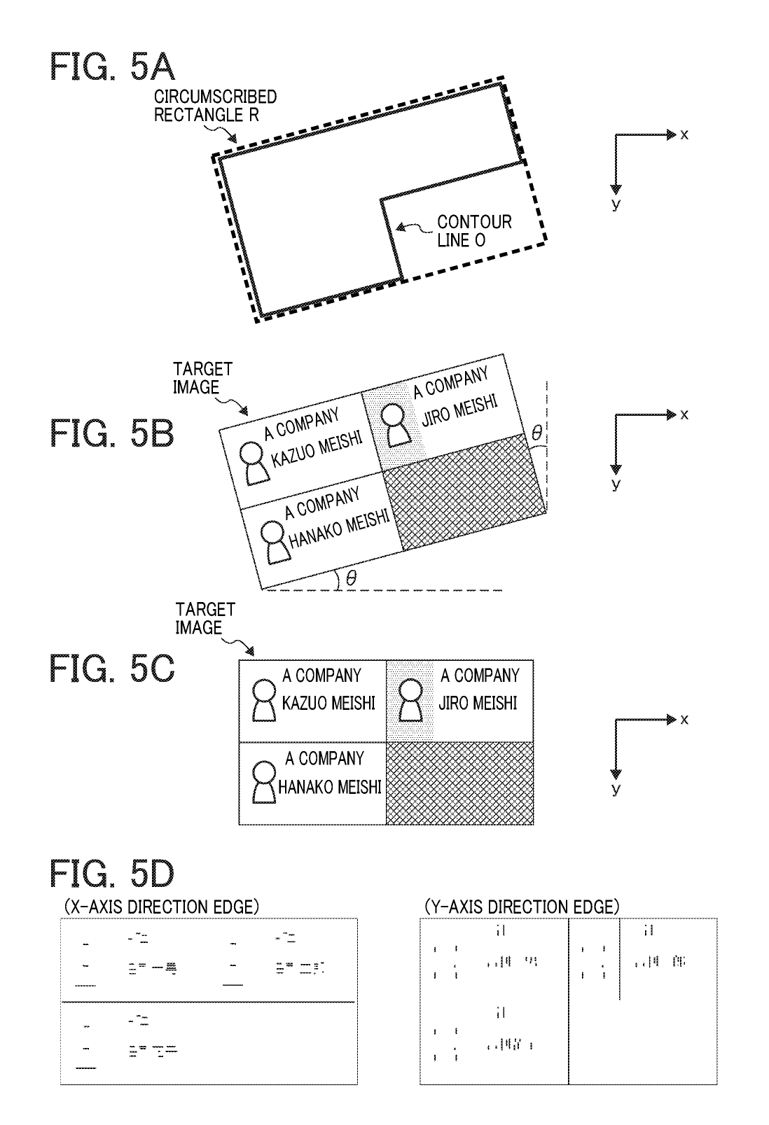

In subsequent step S105, the target image extractor 103 limits the area to a circumscribed rectangle R of the contour line O illustrated in FIG. 5A, and extracts the target image. FIG. 5B illustrates the target image extracted in step S105.

In subsequent step S106, the skew corrector 104 performs skew correction to the target image extracted in previous step S105. Specifically, correction is performed such that any side of the rectangular target image is parallel to the X-axis direction (main-scanning direction) or the Y-axis direction (sub-scanning direction) of the scanned image. FIG. 5C illustrates the target image after skew correction. Incidentally, in the present embodiment, by using character information or the like included in the target image, skew correction accuracy may be improved.

In subsequent step S107, the edge detector 105 extracts the edge in the X-axis direction and the edge in the Y-axis direction from the target image after skew correction. FIG. 5D illustrates the edge in the X-axis direction and the edge in the Y-axis direction extracted from the target image after skew correction. In the present embodiment, at this time, as illustrated in FIG. 5D, an edge component is extracted due to a shadow that occurs between the adjacent documents (business cards), or between the document (business card) and the reading surface.

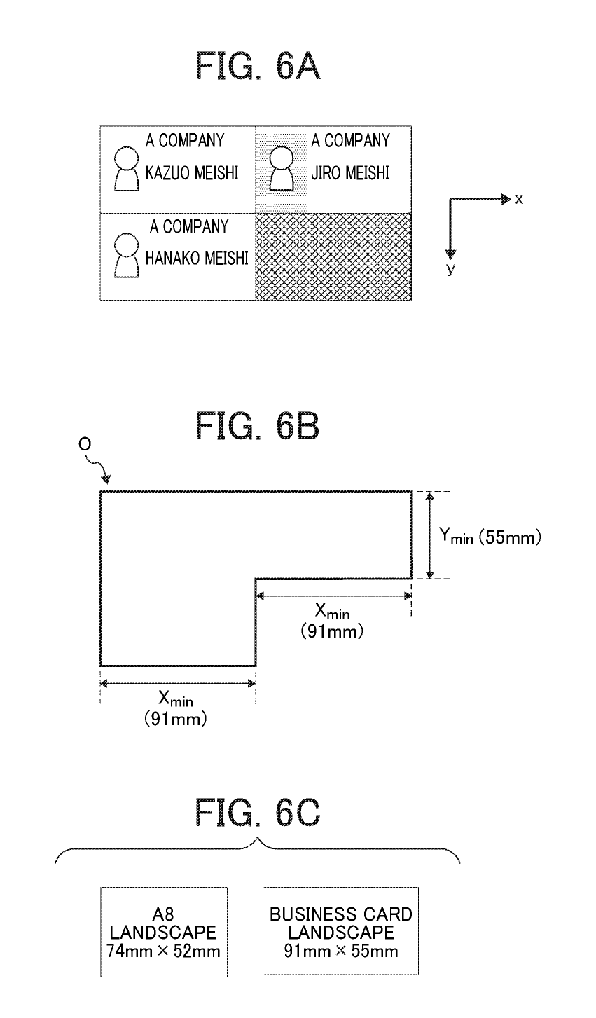

In subsequent step S108, the shortest straight line identifier 106 identifies the shortest straight line Xₘᵢₙ in the X-axis direction and the shortest straight line Yₘᵢₙ in the Y-axis direction, from among straight lines constituting the contour line O (FIG. 6B) of the document area included in the target image after skew correction illustrated in FIG. 6A. In this case, the shortest straight line identifier 106 identifies the shortest straight line Xₘᵢₙ and the shortest straight line Yₘᵢₙ, from among six straight lines constituting the contour line O of the document area, as illustrated in FIG. 6B.

In subsequent step S109, the candidate size selector 107 selects a candidate of the cut out size (hereinafter, referred to as a candidate size) on the basis of the lengths of the shortest straight line Xₘᵢₙ and the shortest straight line Yₘᵢₙ identified. Specifically, collating the length of the shortest straight line Xₘᵢₙ and the length of the shortest straight line Xₘᵢₙ identified in previous step S108 with a candidate size management table 500 retained in the storage area 113, one or more document sizes are selected as the candidate sizes.

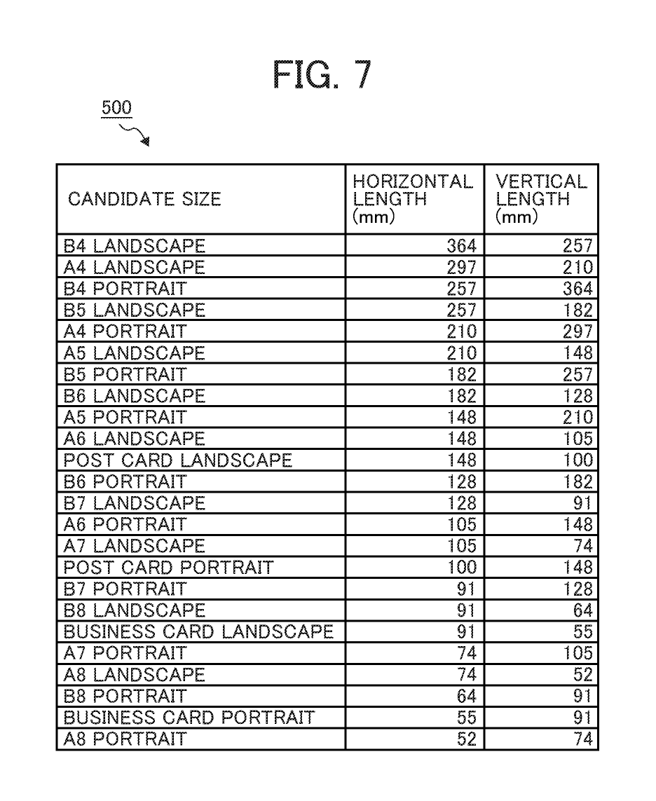

Here, FIG. 7 illustrates an example of the candidate size management table 500. As illustrated in FIG. 7, the candidate size management table 500 stores 24 candidate sizes in total. In the present embodiment, for each of 12 existing document sizes (A4 to A8, B4 to B8, post card, business card), two candidate sizes of “landscape” and “portrait” are defined, and then the horizontal length (mm) and the vertical length (mm) are registered in the candidate size management table 500, in association with each candidate size. Describing this with an “A4” size as an example, in the present embodiment, for the “A4” size, two candidate sizes of “A4 landscape” and “A4 portrait” are defined, and then the horizontal length (297 mm) and the vertical length (210 mm) of the “A4 landscape” is stored in the table, and the horizontal length (210 mm) and the vertical length (297 mm) of the “A4 portrait” is stored in the table.

In step S109, the candidate size selector 107 compares the horizontal length and the vertical length of each candidate size stored in the candidate size management table 500 described above with the lengths of the shortest straight line Xₘᵢₙ and the shortest straight line Yₘᵢₙ identified by the shortest straight line identifier 106, and searches for and selects one or more candidate sizes each of which has a horizontal length of the document size equal to or less than the length of the shortest straight line Xₘᵢₙ and a vertical length of the document size equal to or less than the length of the shortest straight line Yₘᵢₙ.

In the example illustrated in FIG. 6B, on the basis of the fact that the length of the shortest straight line Xₘᵢₙ is 91 mm and the length of the shortest straight line Yₘᵢₙ is 55 mm, the candidate size selector 107 searches for and selects the candidate size that has the horizontal length equal to or less than 91 mm and the vertical length equal to or less than 55 mm, from among 24 candidate sizes stored in the candidate size management table 500. As a result, “A8 landscape” and “business card landscape” illustrated in FIG. 6C are selected as the candidate sizes.

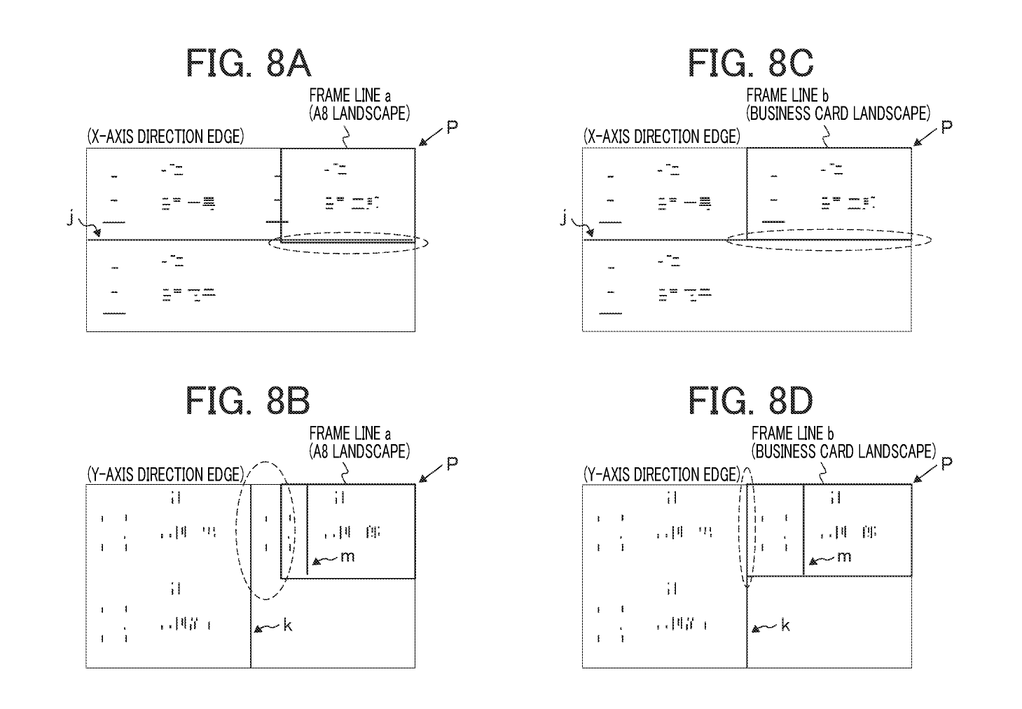

In subsequent step S110, the fitness calculator 108 selects any one of vertexes from among four vertexes included in the rectangular target image illustrated in FIG. 6A, and then compares the frame line of the selected candidate size with the edges of the target image, using the selected vertex as a reference point, and calculates the fitness of the candidate size on the basis of the comparison result. Hereinafter, the processing of step S110 will be specifically described with reference to FIGS. 8A to 8D.

In the present embodiment, first, the frame line is defined corresponding to the two candidate sizes (“A8 landscape” and “business card landscape”) selected in the previous step. Specifically, as a frame line corresponding to “A8 landscape”, a rectangular “frame line a” is defined having the length in the X-axis direction “74 mm” and the length in the Y-axis direction “52 mm”, and as a frame line corresponding to “business card landscape”, a rectangular “frame line b” is defined having the length in the X-axis direction “91 mm” and the length in the Y-axis direction “55 mm”. Incidentally, at this time, straight lines constituting the frame line has a predetermined pixel width as a margin.

Subsequently, as illustrated in FIG. 8A, a vertex P is selected as the reference point from among four vertexes included in the target image, and then the frame line a and the X-axis direction edge of the target image are superimposed on each other such that the vertex of the frame line a and the vertex P (reference point) of the target image overlap each other. After that, the number of edge pixels overlapping the straight lines (two lines) in the X-axis direction constituting the frame line a is counted, and the total number of the counted edge pixels is divided by the length in the X-axis direction of the frame line a “74 mm” to obtain a normalized value [X_{NT}].

Subsequently, as illustrated in FIG. 8B, the frame line a and the Y-axis direction edge of the target image are superimposed on each other at the reference point P similarly, and then the number of edge pixels overlapping the straight lines (two lines) in the Y-axis direction constituting the frame line a is counted, and the total number of the counted edge pixels is divided by the length in the Y-axis direction of the frame line a “52 mm” to obtain a normalized value [Y_{NT}].

Finally, a total value of [X_{NT}] and [Y_{NT}] is calculated as fitness of “A8 landscape” corresponding to the frame line a. In this example, as illustrated in FIG. 8A, the straight line in the X-axis direction constituting the frame line a deviates from an edge j that occurs in a boundary line in the X-axis direction between the adjacent documents, and as illustrated in FIG. 8B, the straight line in the Y-axis direction constituting the frame line a deviates from an edge k that occurs in a boundary line in the Y-axis direction between the documents, so that the fitness of “A8 landscape” is calculated low.

Next, the frame line b is processed in a similar procedure. That is, as illustrated in FIG. 8C, the frame line b and the X-axis direction edge of the target image are superimposed on each other at the reference point P, and then the total number of edge pixels overlapping the straight lines (two lines) in the X-axis direction constituting the frame line b is divided by the length in the X-axis direction of the frame line b “91 mm” to obtain a normalized value [X_{NT}]. Subsequently, as illustrated in FIG. 8D, the frame line b and the Y-axis direction edge of the target image are superimposed on each other at the reference point P, and then the total number of edge pixels overlapping the straight lines (two lines) in the Y-axis direction constituting the frame line b is divided by the length in the Y-axis direction of the frame line b “55 mm” to obtain a normalized value [Y_{NT}].

Finally, a total value of [X_{NT}] and [Y_{NT}] is calculated as fitness of “business card landscape” corresponding to the frame line b. In this example, as illustrated in FIG. 8C, the straight line in the X-axis direction constituting the frame line b coincides with the edge j, and as illustrated in FIG. 8D, the straight line in the Y-axis direction constituting the frame line b coincides with the edge k, so that the fitness of “business card landscape” is calculated high.

Referring back to FIG. 3, description will be continued.

In subsequent step S111, the cut out size determiner 109 determines the candidate size for which the maximum fitness is obtained in previous step S110, as a cut out size. In this example, “business card landscape” for which the maximum fitness is obtained is determined as the cut out size, from among the two candidate sizes (“A8 landscape” and “business card landscape”) selected.

Here, it should be noted that an edge m corresponding to a color boundary of two color printed “business card of Jiro Meishi of A company” is extracted from the target image, as illustrated in FIGS. 8B and 8D. In such a case, in a method for determining the document boundary focusing only on a linear edge, the color boundary (edge m) may be erroneously detected as the document boundary; however, in the present embodiment, the fitness is determined between the edge and the frame line of the candidate size, so that a possibility of erroneous detection is low.

In subsequent step S112, the document image cut out unit 110 cuts out an image of the determined cut out size from the target image, using a vertex of the target image as the reference point, the vertex having been used as the reference point when the fitness is calculated. After that, the processing in step S112 is repeated until cut out of the target image is all ended (step S113, No).

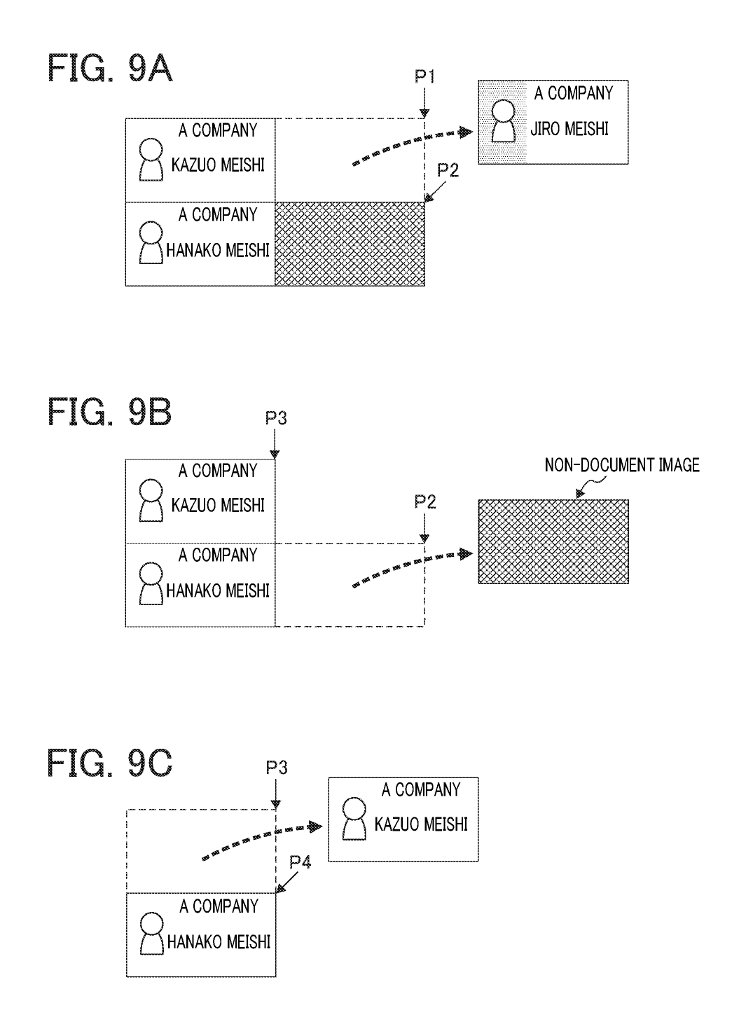

FIGS. 9A to 9C conceptually illustrates the detail of the processing repeated in step S112. In this example, as illustrated in FIG. 9A, first, an image of the “business card landscape” size is cut out from the target image, using a vertex P1 of the target image as the reference point. As a result, an image of “business card of Jiro Meishi of A company” is cut out. Next, as illustrated in FIG. 9B, an image of the “business card landscape” size is cut out from the target image, using a vertex P2 of the target image after ending the first cut out as the reference point. As a result, a black image on which no document is shown (hereinafter, referred to as a non-document image) is cut out. Next, as illustrated in FIG. 9C, an image of the “business card landscape” size is cut out from the target image, using a vertex P3 of the target image after ending the second cut out as the reference point. As a result, an image of “business card of Kazuo Meishi of A company” is cut out. Finally, an image of the “business card landscape” size is cut out from the target image, using a vertex P4 of the target image after ending the third cut out as the reference point. As a result, an image of “business card of Hanako Meishi of A company” is cut out, and at this point in time, cut out of the target image is all ended.

When cut out of the target image is all ended, it is determined whether or not the processing is ended for all document areas extracted in previous step S102, in subsequent step S114. As a result, in a case where an unprocessed document area remains (step S114, No), the processing returns to step S103 again, and the processing described above is repeated. On the other hand, in a case where the processing is ended for all document areas (step S114, Yes), the processing proceeds to step S115.

In subsequent step S115, the non-document image discard unit 112 discards an image on which no document is shown (hereinafter, referred to as a non-document image) from among the images cut out. Specifically, an index indicating the amount of information included in the image is calculated from each image cut out, and in a case where the calculated index is less than a predetermined threshold, the image is discarded as the non-document image. In the present embodiment, a value obtained by dividing an edge amount detected from the image cut out by an area of the image, can be exemplified as the index indicating the amount of information.

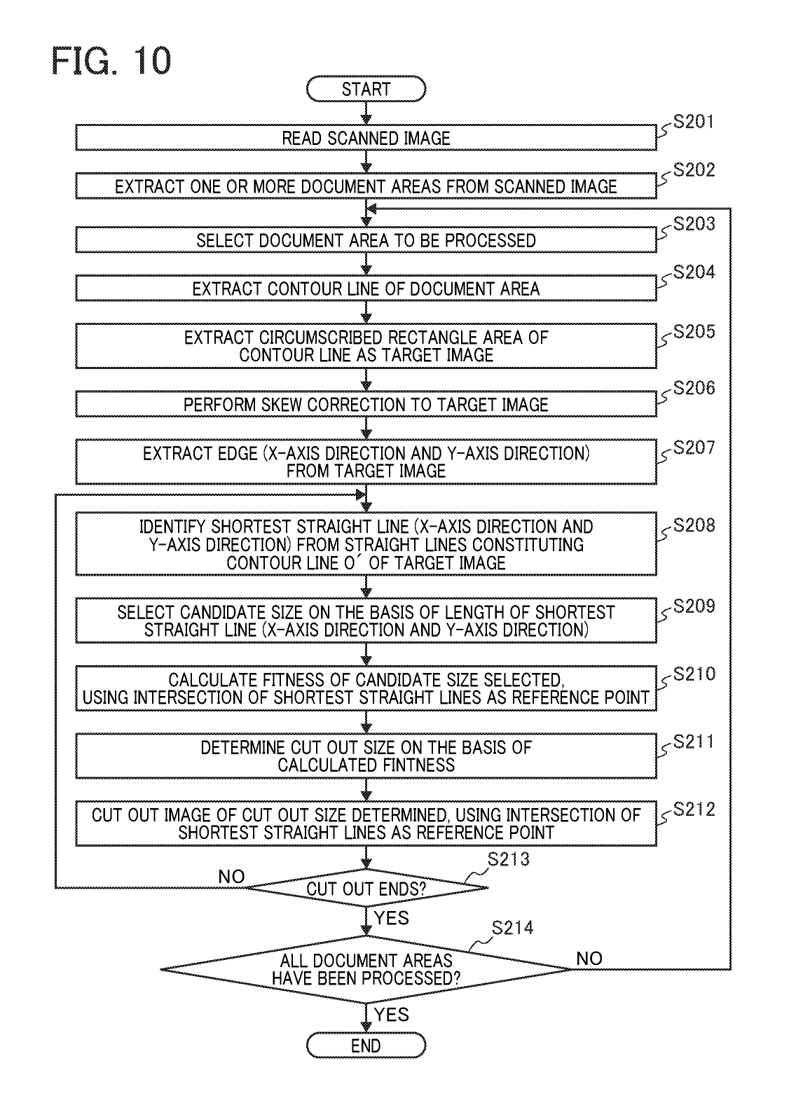

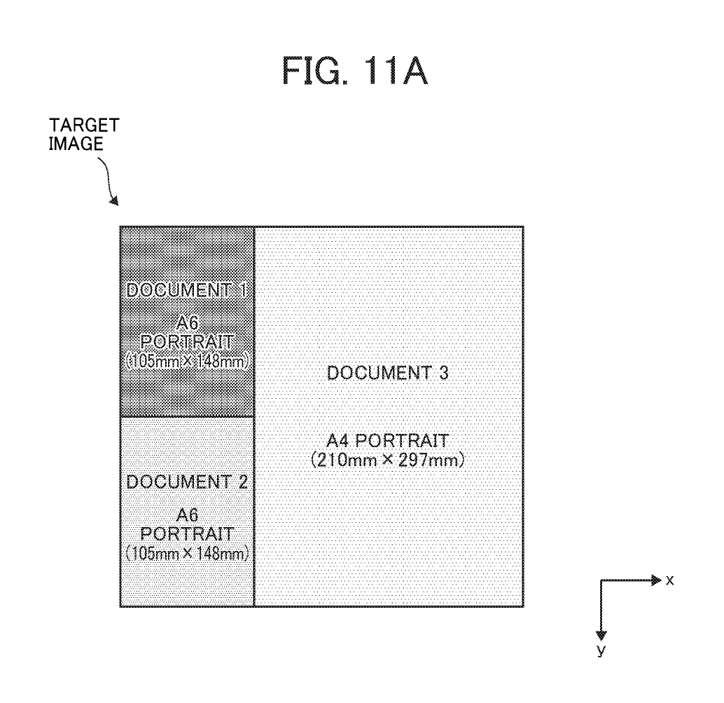

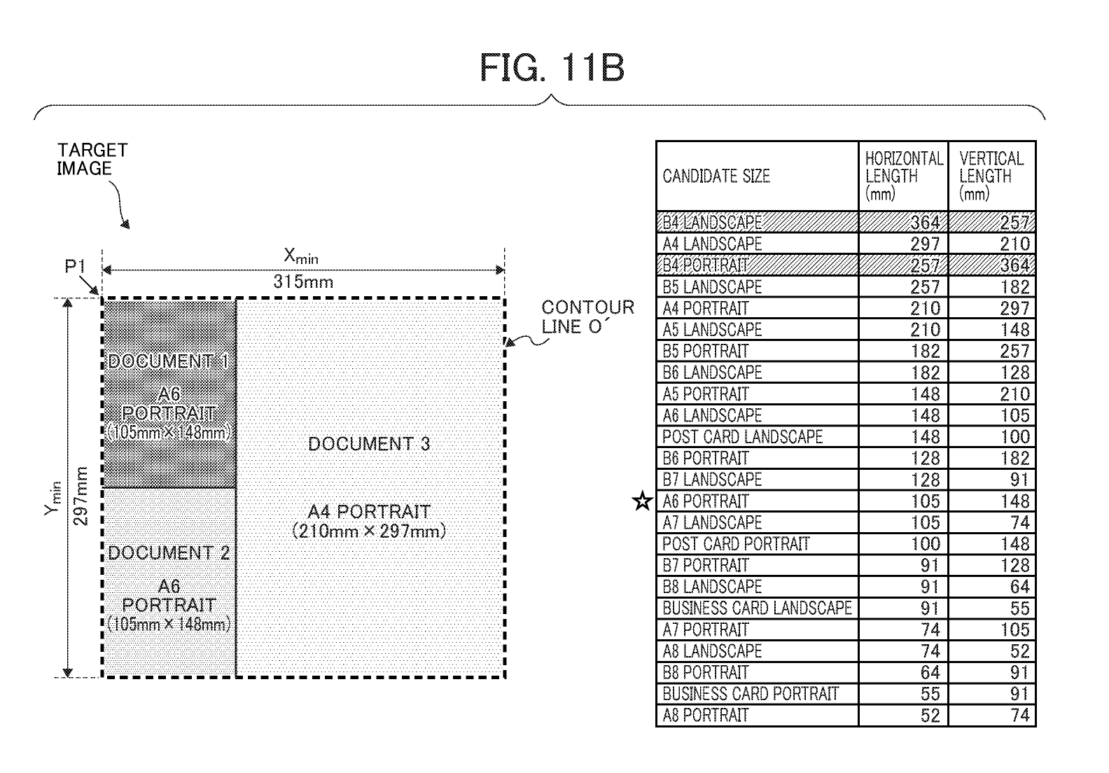

In the above, the processing executed in the “first operation mode” by the image processing device 100 according to the present embodiment has been described. Subsequently, the detail of the processing executed in the “second operation mode” by the image processing device 100 according to the present embodiment will be described with reference to a flowchart illustrated in FIG. 10. However, since the detail of the processing of steps S201 to S207 in FIG. 10 executed in the “second operation mode” is the same as the detail of the processing of steps S101 to S107 in FIG. 3 executed in the “first operation mode”, the description will be omitted here, and the processing of step S208 and subsequent steps will be exclusively described below. Incidentally, the following description will be made using an example case where the target image illustrated in FIG. 11A is obtained after step S206 (skew correction) in FIG. 10.

In step S208, the shortest straight line identifier 106 defines a contour line O′ of the target image illustrated in FIG. 11A, and then identifies the shortest straight line Xₘᵢₙ in the X-axis direction and the shortest straight line Yₘᵢₙ in the Y-axis direction, from among straight lines constituting the contour line O′. In this case, the shortest straight line Xₘᵢₙ and the shortest straight line Yₘᵢₙ are identified, as illustrated in FIG. 11B.

In subsequent step S209, the candidate size selector 107 collates the lengths of the shortest straight line Xₘᵢₙ and the shortest straight line Yₘᵢₙ identified with the candidate size management table 500 retained in the storage area 113, to select one or more document sizes as the candidate sizes. In this example, on the basis of the fact that the shortest straight line Xₘᵢₙ=315 mm and the shortest straight line Yₘᵢₙ=297 mm, the candidate size selector 107 searches for and selects a document size that has the horizontal length equal to or less than 315 mm and the vertical length equal to or less than 297 mm, from among 24 candidate sizes stored in the candidate size management table 500. As a result, 22 document sizes except for “B4 landscape” and “B4 portrait” are selected as the candidate sizes, from among 24 candidate sizes.

In subsequent step S210, the fitness calculator 108 calculates the fitness of each of the selected candidate sizes, in the same procedure as the “first operation mode”, using a vertex of the target image corresponding to an intersection P1 between the shortest straight line Xₘᵢₙ and the shortest straight line Yₘᵢₙ as the reference point, as illustrated in FIG. 11B.

In subsequent step S211, the cut out size determiner 109 determines the cut out size on the basis of the fitness calculated in previous step S210, in the same procedure as the “first operation mode”. In this case, the P1 is used as the reference point, so that “A6 portrait” is determined as the cut out size from among 22 candidate sizes.

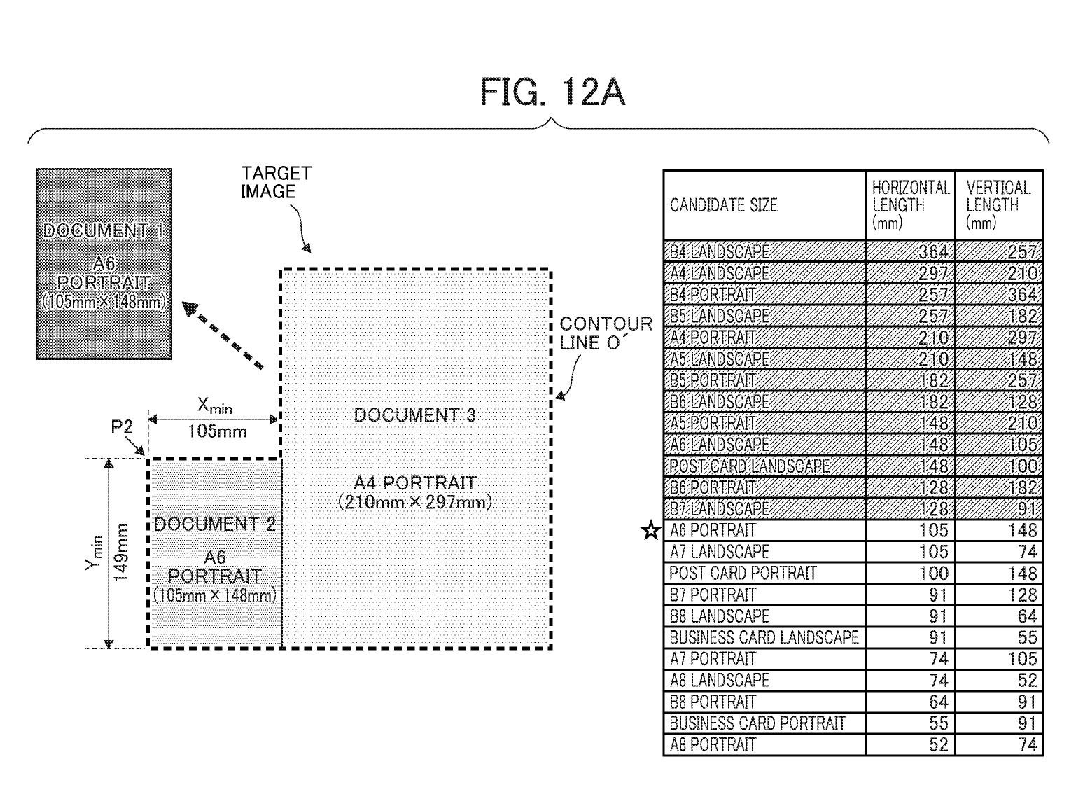

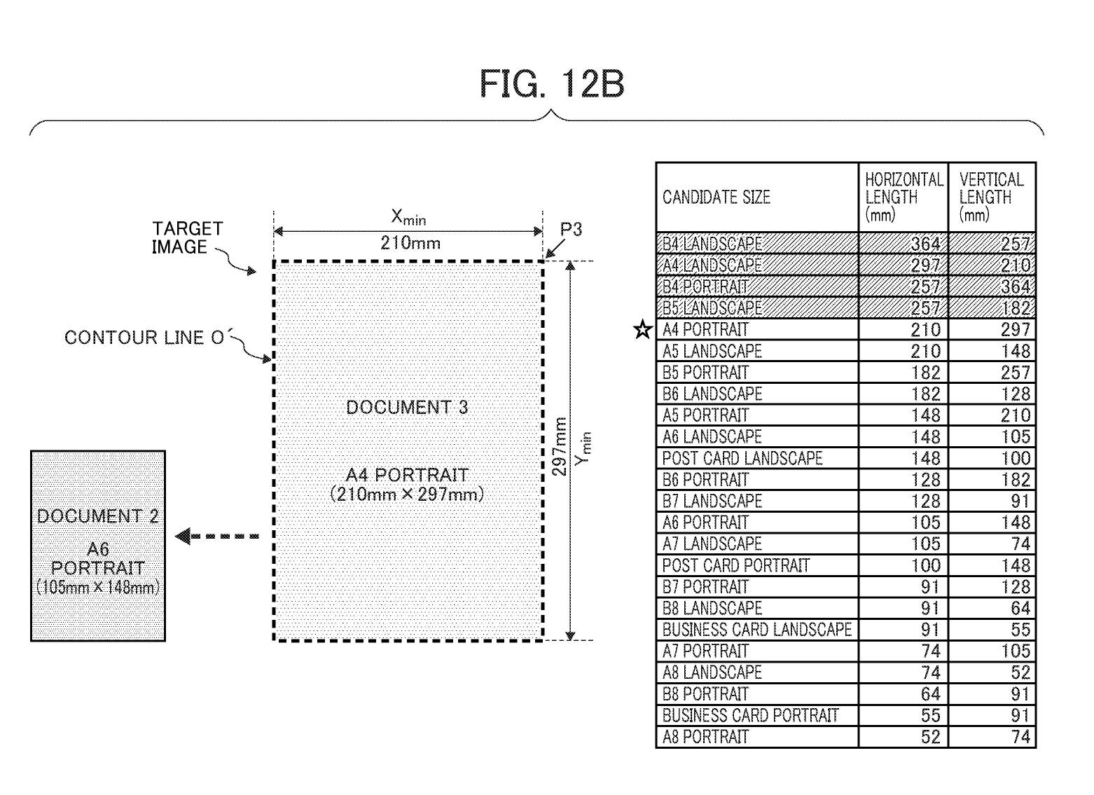

In subsequent step S212, the document image cut out unit 110 cuts out an image of the “A6 portrait (105 mm×148 mm)” size from the target image, using the P1 as the reference point. As a result, as illustrated in FIG. 12A, a document image is cut out corresponding to a “document 1”.

In subsequent step S213, it is determined whether or not cut out of the target image has all been ended. At this point in time, cut out has not been ended (step S213, No), so that the processing returns to step S208 again.

In subsequent step S208, the shortest straight line identifier 106 defines a contour line O′ of the target image after ending the first cut out as illustrated in FIG. 12A, and identifies the shortest straight line Xₘᵢₙ and the shortest straight line Yₘᵢₙ, from among straight lines constituting the contour line O′.

In subsequent step S209, on the basis of the fact that the shortest straight line X₁=105 mm and the shortest straight line Yₘᵢₙ=149 mm, the candidate size selector 107 searches for and selects a document size that has the horizontal length equal to or less than 105 mm and the vertical length equal to or less than 149 mm, from among 24 document sizes stored in the candidate size management table 500. As a result, 11 document sizes (“A6 portrait”, “A7 landscape”, “post card portrait” . . . ) are selected as the candidate sizes, from among 24 document sizes.

In subsequent step S210, the fitness calculator 108 calculates the fitness of each of the selected candidate sizes in a procedure similar to the “first operation mode”, using a vertex of the target image corresponding to an intersection P2 between the shortest straight line Xₘᵢₙ and the shortest straight line Yₘᵢₙ of the target image illustrated in FIG. 12A as the reference point.

In subsequent step S211, the cut out size determiner 109 determines the cut out size on the basis of the fitness calculated in previous step S210, in the same procedure as the “first operation mode”. In this case, the P2 is used as the reference point, so that “A6 portrait” is determined as the cut out size.

In subsequent step S212, the document image cut out unit 110 cuts out an image of the “A6 portrait (105 mm×148 mm)” size, using the P2 as the reference point. As a result, as illustrated in FIG. 12B, a document image is cut out corresponding to a “document 2”.

In subsequent step S213, it is determined whether or not cut out of the target image has all been ended. At this point in time, cut out has not been ended (step S213, No), so that the processing returns to step S208 again.

In subsequent step S208, the shortest straight line identifier 106 defines a contour line O′ of the target image after ending the second cut out, and identifies the shortest straight line Xₘᵢₙ and the shortest straight line Yₘᵢₙ, from among straight lines constituting the contour line O′. In this case, the shortest straight line Xₘᵢₙ and the shortest straight line Yₘᵢₙ are identified, as illustrated in FIG. 12B.

In subsequent step S209, on the basis of the fact that the shortest straight line Xₘᵢₙ=210 mm and the shortest straight line Yₘᵢₙ=297 mm, the candidate size selector 107 searches for and selects a document size that has the horizontal length equal to or less than 210 mm and the vertical length equal to or less than 297 mm, from among 24 document sizes stored in the candidate size management table 500. As a result, 20 document sizes (“A4 portrait”, “A5 landscape”, “B5 portrait” . . . ) are selected as the candidate sizes, from among 24 document sizes.

In subsequent step S210, the fitness calculator 108 calculates the fitness of each of the selected candidate sizes in the procedure similar to the “first operation mode”, using a vertex of the target image corresponding to an intersection P3 between the shortest straight line Xₘᵢₙ and the shortest straight line Yₘᵢₙ illustrated in FIG. 12B as the reference point.

In subsequent step S211, the cut out size determiner 109 determines the cut out size on the basis of the fitness calculated in previous step S210, in the same procedure as the “first operation mode”. In this case, the P3 is used as the reference point, so that “A4 portrait” is determined as the cut out size.

In subsequent step S212, the document image cut out unit 110 cuts out an image of the “A4 portrait (210 mm×297 mm)” size from the target image, using the P3 as the reference point. As a result, a document image is cut out corresponding to a “document 3” illustrated in FIG. 12B.

In subsequent step S213, it is determined whether or not cut out of the target image has all been ended. At this point in time, cut out has all been ended (step S213, Yes), so that the processing proceeds to step S214. In subsequent step S214, it is determined whether or not the processing has been ended for all document areas extracted in previous step S202. As a result, in a case where an unprocessed document area remains (step S214, No), the processing returns to step S203 again, and the processing described above is repeated. On the other hand, in a case where the processing has been ended for all document areas (step S214, Yes), the processing is ended.

In the above, the processing executed by the image processing device 100 according to the embodiment has been described for each operation mode. As described above, according to the first operation mode, it is possible to accurately cut out the image of each document from the scanned image of the reading surface on which the documents of the same size are laid, and according to the second operation mode, it is possible to accurately cut out the image of each document from the scanned image of the reading surface on which the documents are laid in a rectangular shape.

Subsequently, the reference point will be described that is used at the time of calculation of fitness of the candidate size and at the time of cut out of the document image.

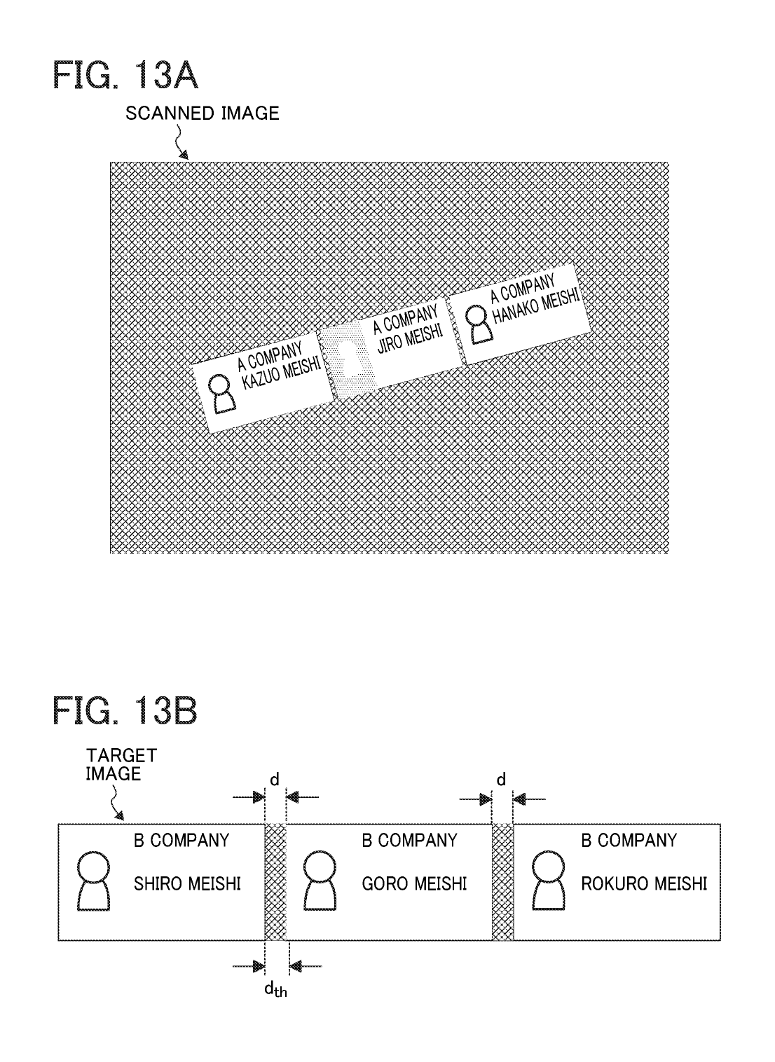

In the above-described embodiment, calculation of fitness of the candidate size and cut out of the document image are performed using the vertex of the target image as the reference point. In a case where the vertex of the target image is used as the reference point, from the target image illustrated in FIG. 13B extracted from the scanned image illustrated in FIG. 13A, the document image is cut out in a procedure as follows.

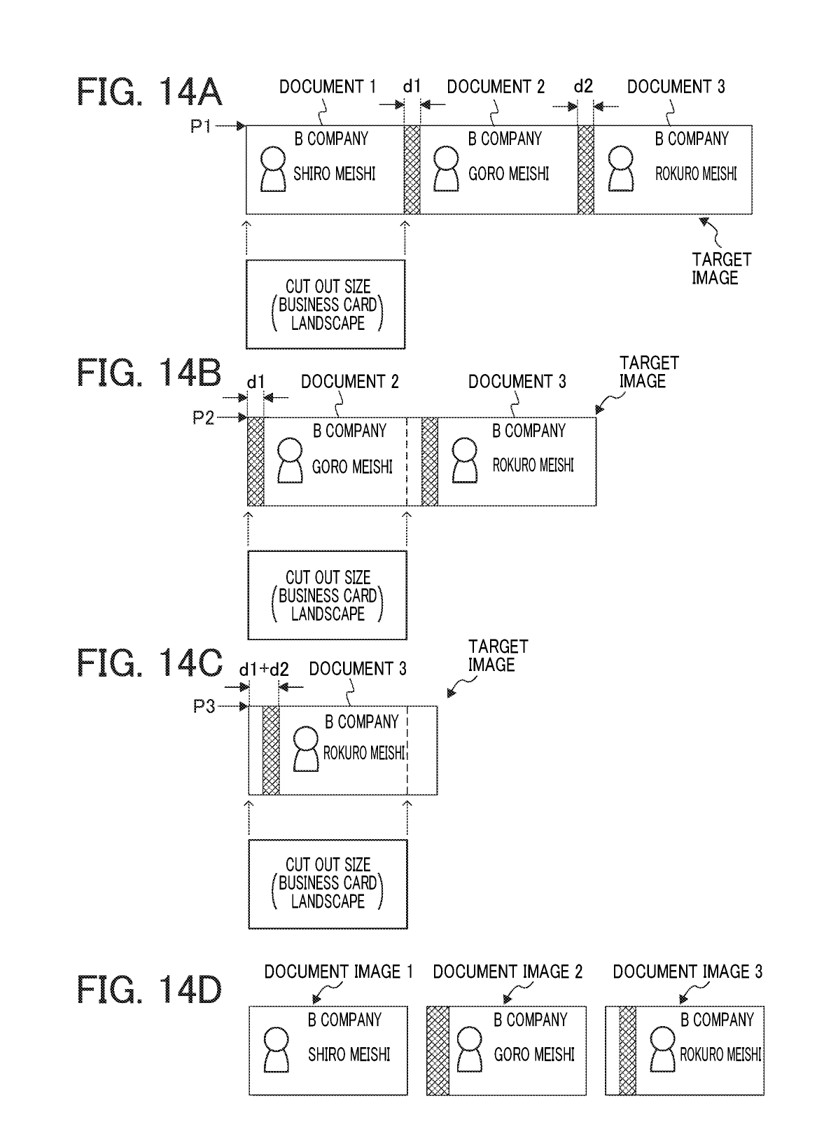

First, as illustrated in FIG. 14A, the vertex P1 is selected from among four vertexes of the target image, and a document image 1 is cut out using the selected vertex P1 as the reference point. Next, as illustrated in FIG. 14B, the vertex P2 is selected from among four vertexes of the target image after ending the first cut out, and a document image 2 is cut out using the selected vertex P2 as the reference point. Finally, as illustrated in FIG. 14C, the vertex P3 is selected from among four vertexes of the target image after ending the second cut out, and a document image 3 is cut out using the selected vertex P3 as the reference point.

In a case where the vertex of the target image is used as the reference point in this way, in a case where there is a gap d1 between the document 1 and the document 2 and there is a gap d2 between the document 2 and the document 3, the reference point P2 deviates from the actual vertex of the document 2 by d1, and the reference point P3 deviates from the actual vertex of the document 3 by d1+d2. At this time, in a case where the gaps d1 and d2 are negligibly small, there is no substantial hindrance; however, in a case where the gaps d1 and d2 are large, there is a possibility that the document image is not correctly cut out as illustrated in FIG. 14D.

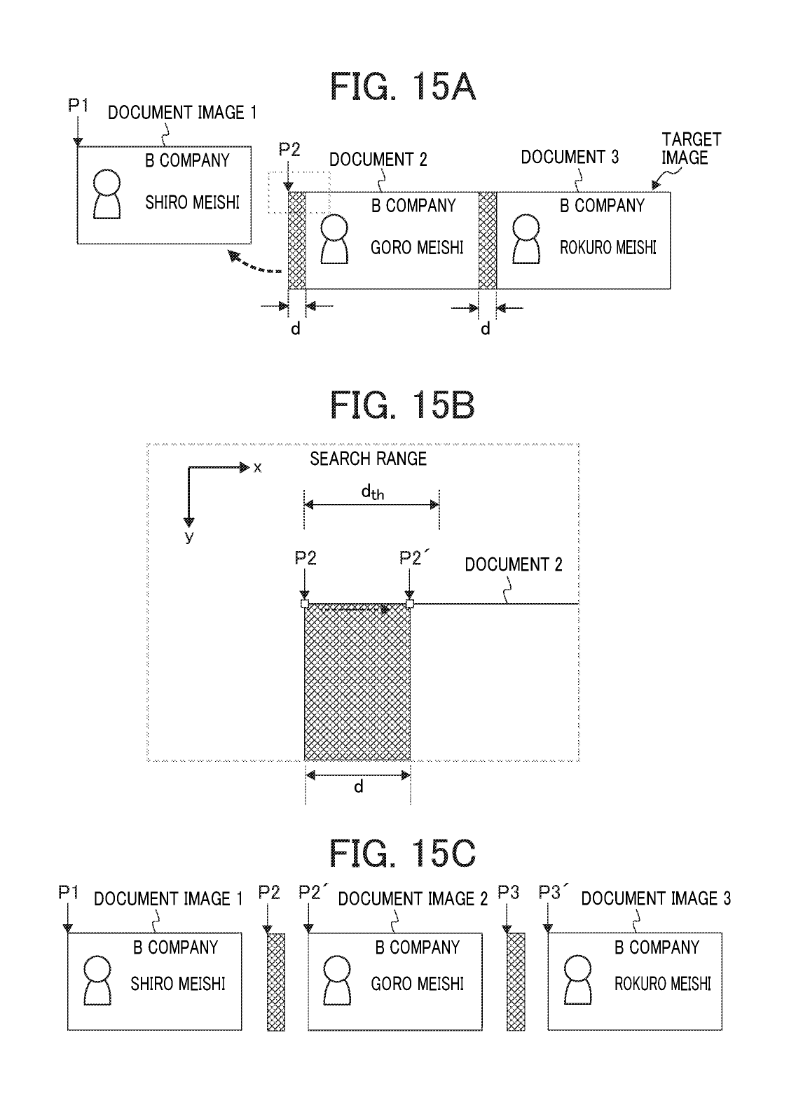

In this regard, an alternative method for determining the reference point will be described with reference to FIGS. 15A to 15C. FIG. 15A illustrates the target image after cutting out the document image 1 on the basis of the reference point P1 from the target image illustrated in FIG. 13B, and FIG. 15B illustrates an enlarged view of the vicinity of the vertex P2 of the target image after cutting out the document image 1.

In the alternative method, as illustrated in FIG. 15B, a luminance gradient is measured from the vertex P2 of the target image toward the x-axis positive direction, and a point at which the luminance gradient is the maximum is determined as a reference point P2′, and then the document image 2 is cut out on the basis of the determined reference point P2′. Incidentally, at this time, up to a point separated from the vertex P2 in the x-axis positive direction by a threshold d±(a distance threshold used when the document area extractor 101 extracts the document area) is a search range of the reference point P2′. However, in a case where the maximum value of the luminance gradient in the search range does not reach a predetermined threshold bₜₕ, it is regarded that there is no gap between the document 1 and the document 2, and the vertex P2 of the target image is determined as the reference point P2′. After that, in a similar procedure, a reference point P3′ is determined, and the document image 3 is cut out on the basis of the determined reference point P3′. As a result, as illustrated in FIG. 15C, the document image 2 corresponding to the document 2 and the document image 3 corresponding to the document 3 are correctly cut out.

Incidentally, in FIGS. 15A to 15C, an example has been described where the documents are adjacent to each other in the X-axis direction. In a case where the documents are adjacent to each other in the Y-axis direction, in a procedure similar to the procedure described above, search for the reference point P′ is performed from the vertex P of the target image toward the Y-axis positive direction.

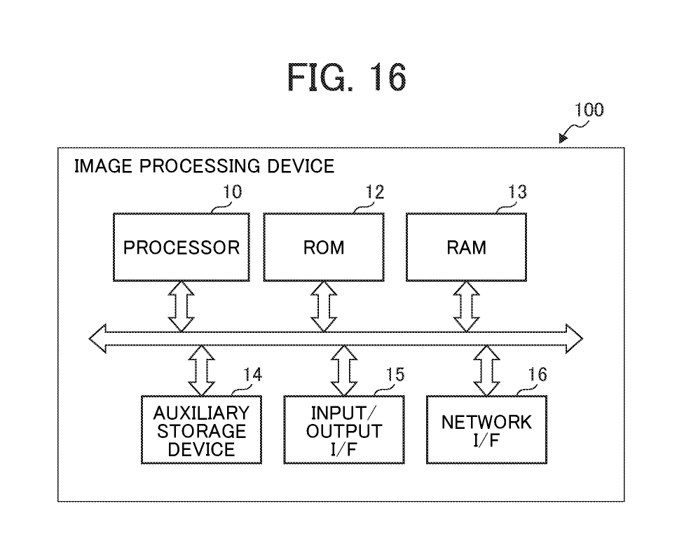

Finally, a hardware configuration will be described of a computer constituting the image processing device 100 according to the present embodiment with reference to FIG. 16.

Information Processing Device

As illustrated in FIG. 16, the computer constituting the image processing device 100 according to the present embodiment includes a processor 10 controlling operation of the entire device, read-only memory (ROM) 12 storing a boot program and a firmware program, random access memory (RAM) 13 providing an execution space for the program, an auxiliary storage device 14 for storing an operating system (OS) and programs for causing the image processing device 100 to execute the functions described above, an input/output interface 15 for connecting to an external device, and a network interface 16 for connecting to a network.

Incidentally, each function of the above-described embodiment can be implemented by a program described in C, C++, C#, Java (registered trademark), or the like. The program according to the present embodiment can be stored in a recording medium such as a hard disk device, CD-ROM, magnetooptic disc (MO), DVD, flexible disk, EEPROM, EPROM and distributed, or can be transferred via the network in a possible format for the other devices.

As described above, according to the embodiment of the present disclosure, the image processing device is provided capable of cutting out the image of each document from the scanned image of the reading surface on which a plurality of documents is laid, without requiring specification of the size and the orientation of the documents.

The above-described embodiments are illustrative and are not intended to limit the present disclosure. Thus, numerous additional modifications and variations are possible in light of the above teachings. For example, elements and/or features of different illustrative embodiments may be combined with each other and/or substituted for each other within the scope of the present invention.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

What is claimed is:

1. An image processing device comprising
a processor to:
extract a target image including a document area from a scanned image of a plurality of documents laid on a reading surface;
perform skew correction to the target image extracted;
detect edges in an X-axis direction and a Y-axis direction from the target image after the skew correction;
compare the edges with a frame line of a candidate size that is a candidate for a document size, to calculate a fitness of the candidate size;
determine the candidate size for which a maximum fitness is calculated, as a cut out size; and
cut out an image of the cut out size determined, from the target image.

2. The image processing device according to claim 1,
wherein the processor identifies a first straight line having a shortest length in the X-axis direction and a second straight line having a shortest length in the Y-axis direction, from among straight lines constituting a contour line of the document area, and
selects one or more document sizes each of which has a horizontal length equal to or less than the length of the first straight line and a vertical length equal to or less than the length of the second straight line, as the candidate size, from among a plurality of document sizes.

3. The image processing device according to claim 2,
wherein the plurality of document sizes are existing document sizes.

4. The image processing device according to claim 1,
wherein the processor extracts an area corresponding to a circumscribed rectangle of the contour line of the document area, as the target image, from the scanned image.

5. The image processing device according to claim 1,
wherein the processor compares the edges with the frame line of the candidate size, using a vertex of the target image as a reference point.

6. The image processing device according to claim 5,
wherein the processor cuts out the image of the cut out size, using the vertex as the reference point.

7. The image processing device according to claim 1,
wherein the processor discards a non-document image on which no document is shown, from among images cut out from the target image.

8. A method of cutting out images of a plurality of documents from a scanned image of the plurality of documents laid on a reading surface,
the method comprising:
extracting a target image including an document area from the scanned image;
performing skew correction to the target image extracted;
detecting edges in an X-axis direction and a Y-axis direction from the target image after the skew correction;
comparing the edges with a frame line of a candidate size that is a candidate for a document size, to calculate a fitness of the candidate size;
determining the candidate size for which a maximum fitness is calculated, as a cut out size; and
cutting out an image of the cut out size determined, from the target image.

9. The method according to claim 8, further comprising:
identifying a first straight line having a shortest length in the X-axis direction and a second straight line having a shortest length in the Y-axis direction, from among straight lines constituting a contour line of the document area; and
selecting one or more document sizes, each of which has a horizontal length equal to or less than the length of the first straight line and a vertical length equal to or less than the length of the second straight line, as the candidate size, from among a plurality of document sizes.

10. The method according to claim 9, wherein
the plurality of document sizes are existing document sizes.

11. The method according to claim 8, wherein
the extracting includes extracting an area corresponding to a circumscribed rectangle of the contour line of the document area, as the target image, from the scanned image.

12. The method according to claim 8, wherein
the calculating includes comparing the edges with the frame line of the candidate size, using a vertex of the target image as a reference point.

13. The method according to claim 12, wherein
the cutting out includes cutting out an image of the cut out size, using the vertex as the reference point.

14. The method according to claim 8, further comprising
discarding a non-document image on which no document is shown, from among images cut out from the target image.

15. A non-transitory recording medium storing program codes that causes an image processing device to execute a method,
the method comprising:
extracting a target image including a document area from a scanned image of a plurality of documents laid on a reading surface;
performing skew correction to the target image extracted;
detecting edges in an X-axis direction and a Y-axis direction from the target image after the skew correction;
comparing the edges with a frame line of a candidate size that is a candidate for a document size, to calculate a fitness of the candidate size;
determining the candidate size for which a maximum fitness is calculated, as a cut out size; and
cutting out an image of the cut out size determined, from the target image.
